(19) United States
(12) Patent Application Publication
(10) Pub. No.: US 2013/0058075 A1
(43) Pub. Date: Mar. 7, 2013

(54) TWO-SIDED LAMP

(71) Applicant: Robert WANG, Luch (TW)

(72) Inventor: Robert WANG, Luch (TW)

(21) Appl. No.: 13/223,434

(22) Filed: Sep. 1, 2011

(51) Int. Cl. F21S 8/04

(52) U.S. Cl. 362/147

(57) ABSTRACT

A two-sided lamp includes a lamp seat, a first light source and a second light source. The lamp seat is disposed under a ceiling and keeps a distance with respect to the ceiling. The lamp seat has a top side and a bottom side. The top side faces the ceiling. The first light source is coupled to the bottom side of the lamp seat. The second light source is coupled to the top side of the lamp seat. The light of the first light source illuminates downward to provide direct illumination and the light of the second light source shines on the ceiling and then be reflected downward from the ceiling to provide indirect illumination. The user can turn on the first light source for high illumination or the second light source for soft illumination.

### BACKGROUND OF THE INVENTION

1. Field of the Invention

The present invention relates to a two-sided lamp to provide direct and indirect illumination.

2. Description of the Prior Art

In general, a lamp is disposed on the ceiling of a building to provide direct illumination. However, the direct rays of light are harsh to the eyes, which may dazzle the user. The user cannot concentrate attention and feels tired. Therefore, an indirect illumination apparatus is developed on the market. The lamp is disposed under the ceiling. The light of the lamp shines on the ceiling and then reflected downward to provide soft light. This can improve the shortcomings of direct illumination to provide a good indoor atmosphere.

However, the brightness of the indirect illumination is not better. Usually, a main lamp is mounted on the ceiling for direct illumination and a plurality of auxiliary lamps is mounted under the ceiling for indirect illumination. The user can select direct illumination or indirect illumination as desired. The main lamp and the auxiliary lamps are separate. This occupies much space and increases cost. In particular, the auxiliary lamps must be located close to the ceiling. A plurality of fixtures or another layer of board under the ceiling is required for fixing the auxiliary lamps. Accordingly, the inventor of the present invention has devoted himself based on his many years of practical experiences to solve this problem.

### SUMMARY OF THE INVENTION

The primary object of the present invention is to provide a two-sided lamp which occupies less space and is cost-effective and provides both direct and indirect illumination.

In order to achieve the aforesaid object, the two-sided lamp of the present invention comprises a lamp seat, a first light source and a second light source. The lamp seat is disposed under a ceiling and keeps a distance with respect to the ceiling. The lamp seat has a top side and a bottom side. The top side faces the ceiling. The first light source is coupled to the bottom side of the lamp seat. The second light source is coupled to the top side of the lamp seat.

The two-sided lamp of the present invention has the lamp seat located under the ceiling and kept a distance with respect to the ceiling. The bottom side of the lamp seat is provided with the first light source, and the top side of the lamp seat is provided with the second light source. When the first light source and the second light source are turned on, the light of the first light source will direct illuminate downward to provide direct illumination and the light of the second light source will shine on the ceiling and then be reflected downward from the ceiling to provide indirect illumination. The present invention occupies less space and is cost-effective, without the need to purchase different lamps.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a sectional view according to the preferred embodiment of the present invention;

FIG. 4 is a schematic view according to the preferred embodiment of the present invention when in use;

FIG. 5 is a perspective view according to another embodiment of the present invention; and

FIG. 6 is a perspective view according to a further embodiment of the present invention.

### DETAILED DESCRIPTION OF THE PREFERRED EMBODIMENTS

Embodiments of the present invention will now be described, by way of example only, with reference to the accompanying drawings.

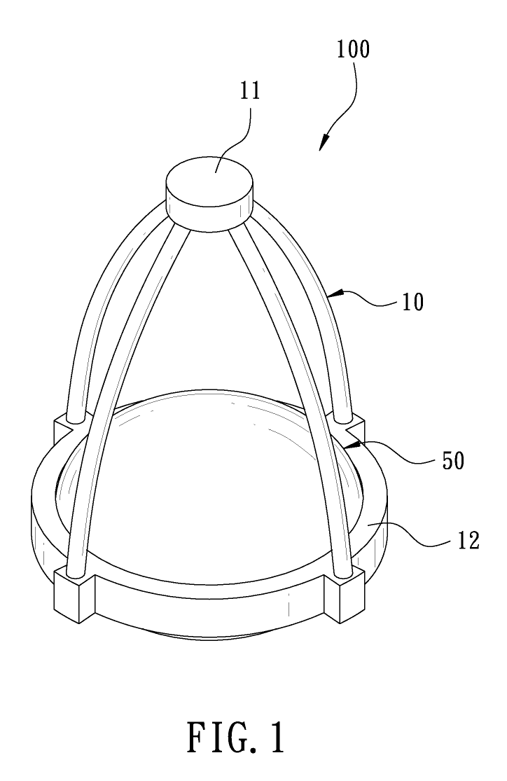

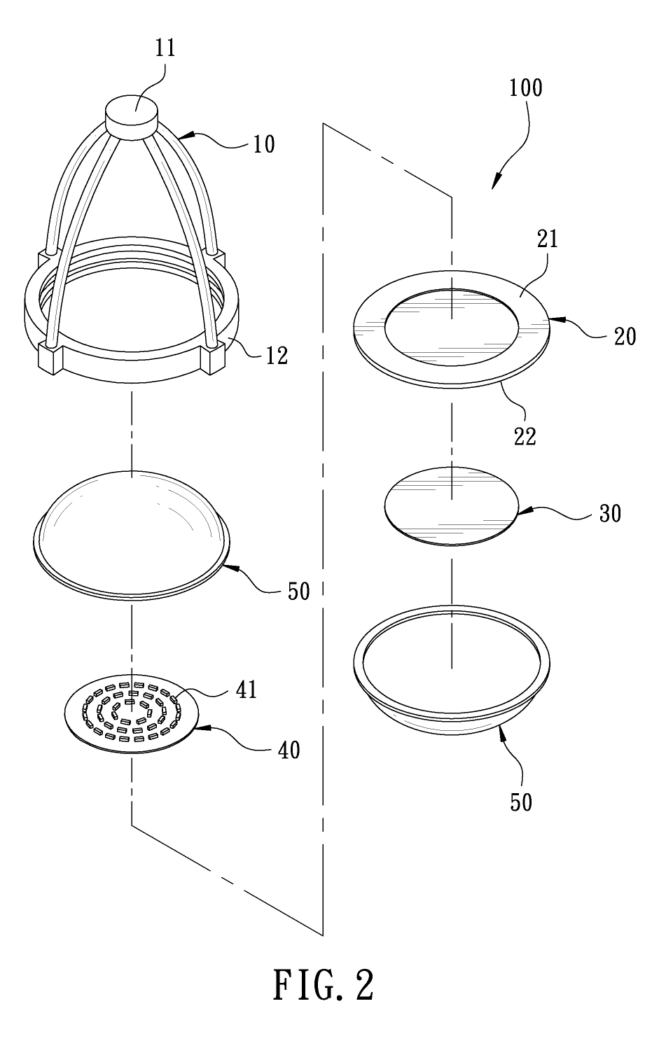

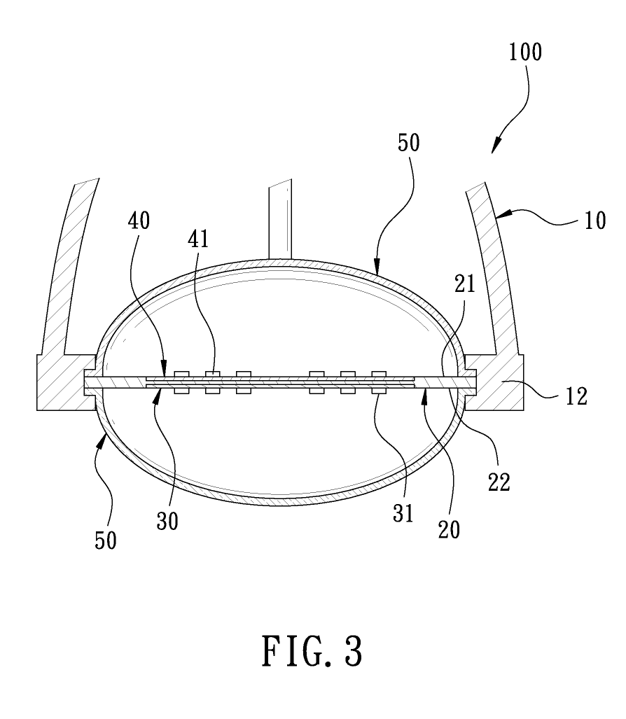

As shown in FIG. 1 through FIG. 4, the two-sided lamp 100 according to a preferred embodiment of the present invention comprises a retaining frame 10, a lamp seat 20, a first light source 30, a second light source 40, and two lampshades 50.

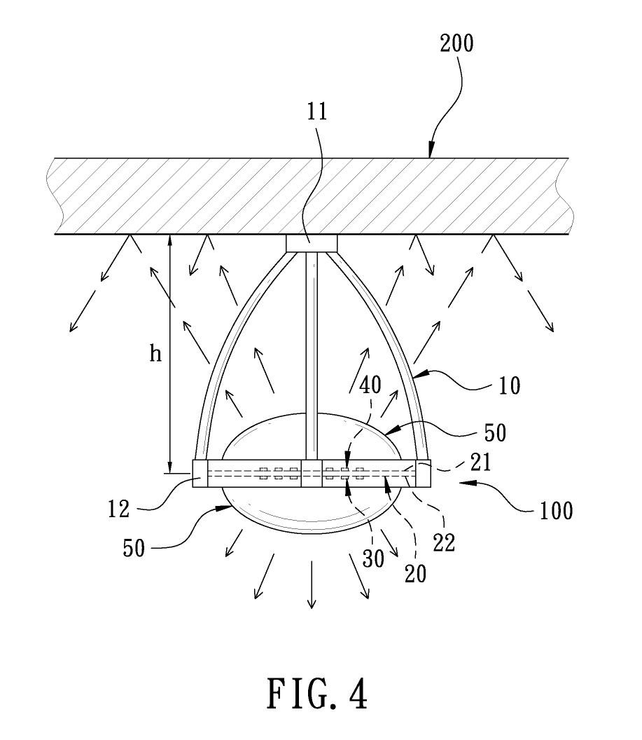

The retaining frame 10 has a retaining portion 11 at one end thereof. The retaining portion 11 is fixed to a ceiling 200, as shown in FIG. 4. Another end of the retaining frame 10 has a connection portion 12 which is located opposite the ceiling 200.

The lamp seat 20 is disposed under the ceiling 200 and keeps a distance h with respect to the ceiling 200. In this embodiment, the lamp seat 20 is fixed to connection portion 12 of the fixing frame 10, and keeps the distance h with respect to the ceiling 200. The lamp seat 20 has a top side 21 and a bottom side 22. The top side 21 faces the ceiling 200.

The first light source 30 is coupled to the bottom side 22 of the lamp seat 2, which is one of a light bulb, a fluorescent lamp, a light emitting diode, a light bar, a light plate or a combination thereof. In this embodiment, the first light source 30 is composed of LEDs.

The second light source 40 is coupled to the top side 21 of the lamp seat 20, which is one of a light bulb, a fluorescent lamp, a light emitting diode, a light bar, a light plate or a combination thereof. In this embodiment, the second light source 30 is composed of LEDs.

The two lampshades 50 are used to cover the top side 21 and the bottom side 22 of the lamp seat 20.

Referring to FIG. 4, the lamp seat 20 is located below the ceiling 200 and keeps the distance h with respect to the ceiling 200. The bottom side 22 of the lamp seat 20 is provided with the first light source 30, and the top side 21 of the lamp seat 20 is provided with the second light source 40. When the first light source 30 is turned on, the light of the first light source 30 will direct illuminate downward to provide direct illumination. When the second light source 40 is turned on, the light of the second light source 40 will shine on the ceiling 200 and then be reflected downward from the ceiling 200 to provide indirect illumination. The user can turn on the first light source 30 or the second light source 40 as desired. For example, when the user needs high illumination for reading or work, he/she can turn on the first light source 30 to get direct illumination. When the user needs soft light for watching a move or having a party, he/she can turn on the second light source 40 to get indirect illumination. Certainly, both the first light source 30 and the second light source 40 can be turned at the same time to provide direct and indirect illumination. The present invention occupies less space and is cost-effective, without the need to purchase different lamps.

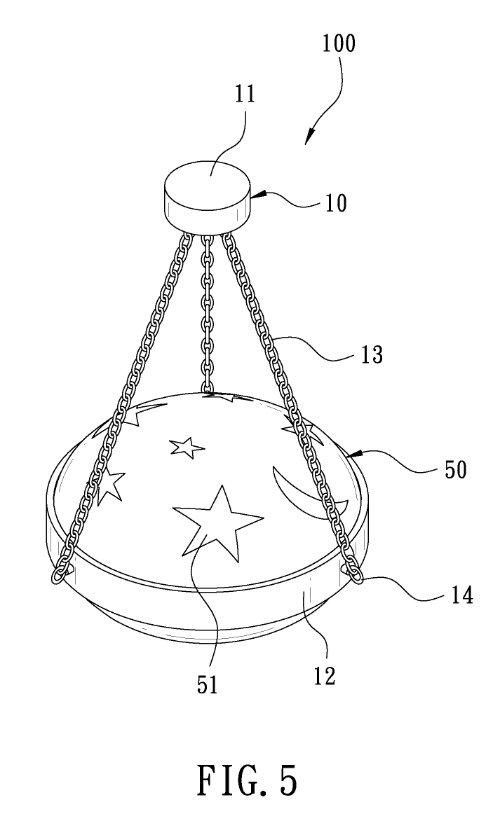

FIG. 5 is a perspective view of another embodiment of the present invention, which is substantially similar to the aforesaid embodiment with the exceptions described hereinafter. The retaining portion 11 of the retaining frame 10 is connected with a plurality of chains 13, and the connection portion 12 of the retaining frame 10 has a circumferential side provided with a plurality of hooks 14 for connection of the chains 13. In this embodiment, the outer side of the lampshade 50 has a pattern 51. When the two-sided lamp 100 is turned on, the pattern 51 will be projected on the ceiling 200 for decoration, so the two-sided lamp 100 is good to see.

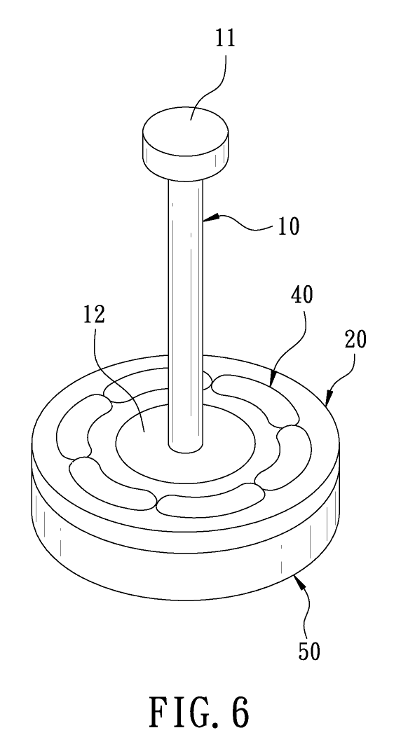

FIG. 6 is a perspective view of a further embodiment of the present invention, which is substantially similar to the aforesaid embodiment with the exceptions described hereinafter. The connection portion 12 is direct connected to the lamp seat 20. The lamp seat 20 is made of a metallic material to have a better radiation effect, which is beneficial for heat radiation of the first light source 30 and the second light source 40. In particular, the two-sided lamp 100 uses LEDs as the first light source 30 and the second light source 40. The heating value of an LED is higher than a traditional light bulb. The lamp seat 20 which is integrally formed can effectively conduct the heat out so as to prevent the LEDs from being damaged because of over heat.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A two-sided lamp, comprising:
a lamp seat disposed under a ceiling and keeping a distance with respect to the ceiling, the lamp seat having a top side and a bottom side, the top side facing the ceiling;
a first light source coupled to the bottom side of the lamp seat; and
a second light source coupled to the top side of the lamp seat.

2. The two-sided lamp as claimed in claim 1, wherein the first light source is one of a light bulb, a fluorescent lamp, a light emitting diode, a light bar, a light plate or a combination thereof.

3. The two-sided lamp as claimed in claim 1, wherein the second light source is one of a light bulb, a fluorescent lamp, a light emitting diode, a light bar, a light plate or a combination thereof.

4. The two-sided lamp as claimed in claim 1, further comprising a retaining frame, the retaining frame having a retaining portion at one end thereof, the retaining portion being fixed to the ceiling, another end of the retaining frame having a connection portion which is located opposite the ceiling, the lamp seat is connected to the connecting portion.

5. The two-sided lamp as claimed in claim 1, wherein the lamp seat is made of a metallic material.

6. The two-sided lamp as claimed in claim 1, wherein two lampshades are provided to cover the top side and the bottom side of the lamp seat.

7. The two-sided lamp as claimed in claim 6, wherein the lampshades have a pattern thereon.
